(19) United States
(12) Patent Application Publication
(10) Pub. No.: US 2025/0182478 A1
(43) Pub. Date: Jun. 5, 2025

(54) GENERATING VIDEOS USING A CENTRALIZED SYSTEM

(71) Applicant: Lemon Inc., Grand Cayman (KY)

(72) Inventors: Zhihao Ouyang, Los Angeles, CA (US); Zhe Jiang, Los Angeles, CA (US); Bin Chen, Los Angeles, CA (US); BaoMan Liu, Los Angeles, CA (US); Dong Guo, Culver City, CA (US)

(21) Appl. No.: 18/529,541

(22) Filed: Dec. 5, 2023

(51) Int. Cl. G06V 20/40; G06V 20/00

(52) U.S. Cl. CPC G06V 20/41; G06V 20/35

(57) ABSTRACT

The present disclosure describes techniques for generating videos using a centralized system. Text is received by the centralized system via a user interface. The text indicates instructions for creating a video. A script for the video is generated based on the text by a machine learning model of the centralized system. The script indicates a series of scenes in the video. A plurality of tasks associated with creating the video is generated based on the script. The plurality of tasks are dispatched to a plurality of tools. The plurality of tools are associated with the centralized system. The centralized system enables the plurality of tools to simultaneously implement the plurality of tasks. Data indicating results of the plurality of tasks is collected from the plurality of tools. Information is displayed on the user interface for accessing the video generated based on the collected data.

### BACKGROUND

Techniques for video generation and/or video editing are widely used in a variety of industries, including social media, videography, advertising, media production, etc. Recently, the demand for video generation and/or editing is getting even stronger. However, conventional video generation and/or editing techniques may not fulfill the needs of users due to various limitations. Therefore, improvements in video generation techniques are needed.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example diagram for generating videos using a centralized system in accordance with the present disclosure.

FIG. 2 shows an example diagram for generating tasks using a centralized system in accordance with the present disclosure.

FIG. 3 shows an example script generated by a centralized system in accordance with the present disclosure.

FIG. 4 shows an example diagram for dispatching tasks using a centralized system in accordance with the present disclosure.

FIG. 5 shows an example diagram for generating videos using a centralized system in accordance with the present disclosure.

FIG. 6 shows an example diagram for generating a video analysis in accordance with the present disclosure.

FIG. 7 shows an example video analysis in accordance with the present disclosure.

FIG. 8 shows an example user interface of a centralized system in accordance with the present disclosure.

FIG. 9 shows an example user interface of a centralized system in accordance with the present disclosure.

FIG. 10 shows an example process for generating videos using a centralized system in accordance with the present disclosure.

FIG. 11 shows an example process for generating videos using a centralized system in accordance with the present disclosure.

FIG. 12 shows an example process for generating and dispatching tasks using a centralized system in accordance with the present disclosure.

FIG. 13 shows an example process for generating videos using a centralized system in accordance with the present disclosure.

FIG. 14 shows an example process for modifying videos using a centralized system in accordance with the present disclosure.

FIG. 15 shows an example process for generating videos using a centralized system in accordance with the present disclosure.

FIG. 16 shows an example computing device which may be used to perform any of the techniques disclosed herein.

### DETAILED DESCRIPTION OF ILLUSTRATIVE EMBODIMENTS

Video production has traditionally been a difficult and resource-intensive task. Video creators rely on a variety of tools (e.g., software and platforms) to perform the different stages in the video production process. Such stages may include drafting scripts, editing content, synchronizing audio-visual elements, adding final touches to the content, such as music and voiceovers, and/or the like. Each of these tools may require specialized knowledge, which can be a barrier for many video creators.

Currently, several artificial intelligence (AI)-based solutions attempt to aid in the content generation process. However, these systems often provide templated responses and lack the ability to produce tailored content based on specific user preferences or nuanced requests. These existing solutions allow for limited interaction, if any, thereby preventing users from guiding the creative process in real-time.

As such, content creators still face challenges. First, video production is a fragmented process, as creators must use multiple platforms for different stages of production, leading to inefficiencies and creative restrictions. Second, existing AI-assisted platforms do not allow creators to customize content. For example, existing AI-assisted platforms do not permit in-depth dialogue or feedback loops with users about video generation, leading to generic and often mismatched content that does not align with the creator's vision. Third, many platforms constrain creativity by offering a narrow range of templates or predefined formats, limiting the creator's ability to produce unique, personalized content. Fourth, the current ecosystem often demands a steep learning curve and proficiency in various tools, discouraging amateur creators or those seeking to quickly produce quality content. For at least these reasons, improved techniques for content creation are described herein.

Described herein is an advanced system that integrates the full spectrum of content creation stages into a single, interactive platform. The system described herein is a centralized system offering end-to-end content generation with interactive real-time feedback. The system described herein utilizes sophisticated AI mechanisms to facilitate a user-guided, customizable creation process, significantly enhancing the accessibility and creative freedom in digital video production.

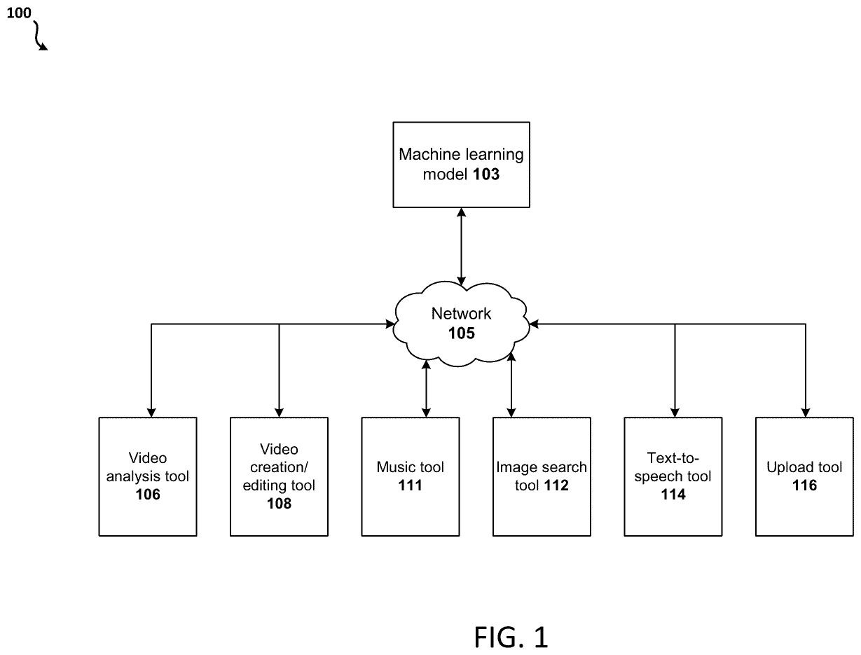

FIG. 1 shows an example centralized system 100 for video generation. The centralized system 100 comprises a machine learning model 103. The machine learning model 103 may be in communication with a plurality of content creation tools via a network 105. The plurality of content creation tools may comprise, for example, a video analysis tool 106, a video creation/editing tool 108, a music tool 111, an image search tool 112, a text-to-speech tool 114, an upload tool 116, and/or any other tool related to video creation. In embodiments, the plurality of creation tools may comprise tools for generating unique background scores, voiceovers, and graphic elements. The plurality of tools may be configured to perform music composition, speech synthesis, and/or graphic design to create various components or elements of a video. For example, the plurality of tools may be configured to create various components or elements of a video based on user-defined criteria (e.g., emotion, genre, brand identity, etc.).

If a user wanted to create or edit a video using various content creation tools, he or she would need to acquire specialized knowledge for each of the content creation tools. It may take the user weeks, months, or even years to master each of the content creation tools. Further, even after the user masters each of the content creation tools, it may be time consuming for the user to first perform one task using one of the content creation tools, then perform another task using a second one of the content creation tools, then perform yet another task using a third one of the content creation tools, and so on.

The centralized system 100 enables a cohesive content creation journey from ideation to a polished final product within a single, comprehensive, and user-friendly platform. A prompt engineering process may be performed to enable the machine learning model 103 to learn functions of the plurality of content creation tools. Descriptions may be generated based on specifications of the plurality of content creation tools. The descriptions may be input into the machine learning model 103. The descriptions may comprise text. The descriptions may describe functions of each of the plurality of content creation tools.

Each of the plurality of content creation tools may require a certain set of parameters to perform the corresponding task. The video analysis tool 106 may require a first set of parameters (e.g., video location, application programming interface (API) key, model name) to perform a video analysis task, the video creation/editing tool 108 may require a second set of parameters to perform a video editing/creation task, the music tool 111 may require a third set of parameters to perform a music task, an image search tool 112 may require a fourth set of parameters to perform an image search task, the text-to-speech tool 114 may require a fifth set of parameters to perform an image search task, the upload tool 116 may require a sixth set of parameters to perform an uploading task, etc. The parameters required by each of the plurality of content creation tools may be different, or some of the plurality of content creation tools may require the same parameters.

In embodiments, the descriptions input into the machine learning model 103 during the prompt engineering process may further depict an API of each of the plurality of content creation tools. The machine learning model 103 may communicate with each of the plurality of content creation tools by calling the API of the corresponding content creation tool. The descriptions input into the machine learning model 103 during the prompt engineering process may further describe the parameters required by each of the plurality of content creation tools for implementing the corresponding task.

In embodiments, the descriptions input into the machine learning model 103 during the prompt engineering process may further describe a video creation or editing pipeline. For example, the descriptions may explain to the machine learning model 103 which tool(s) should be used to write a script, add music, mix music and video clips, and upload the results to the cloud. In embodiments, the descriptions input into the machine learning model 103 during the prompt engineering process may further describe how to create or edit a video. For example, the descriptions may explain various video editing rules to the machine learning model 103. The rules may indicate how to find music for a video (e.g., the theme, mood, and other features of the music should match the video), how to write captions that match the video content, etc. The descriptions input into the machine learning model 103 during the prompt engineering process may further describe how to write scripts. For example, the descriptions may explain to the machine learning model 103 that it should write a script by outlining the actions to be performed in the videos, and writing transcriptions, etc.

A user may communicate with the machine learning model 103 using natural language, such as via a user interface (UI) of the centralized system 100. For example, the user may enter a video generation or editing task, in natural language, into the UI. The centralized system 100 via the machine learning model 103 may determine which of the plurality of content creation tools are necessary to perform the video generation or editing task. The machine learning model 103 may perform the video generation or editing task using the content creation tools determined to be necessary to perform the video generation or editing task. The machine learning model 103 may output the generated/edited video or information for accessing the generated/edited video via the UI.

If the user is not satisfied with the generated/edited video, the user may input, into the UI of the centralized system 100, natural language instructions for modifying the generated/edited video. The machine learning model 103 may determine which of the plurality of content creation tools are necessary to perform the video modification. The machine learning model 103 may perform the video modification using the necessary content creation tools. The centralized system 100 may output the modified video or information for accessing the modified video via the UI. This process may be repeated until the user is satisfied with the video. In this manner, by utilizing the centralized system 100 to generate and/or edit videos, a user does not need to learn and use various content creation tools separately. Instead, the user can easily generate or edit a video without needing to leave the UI of the centralized system 100.

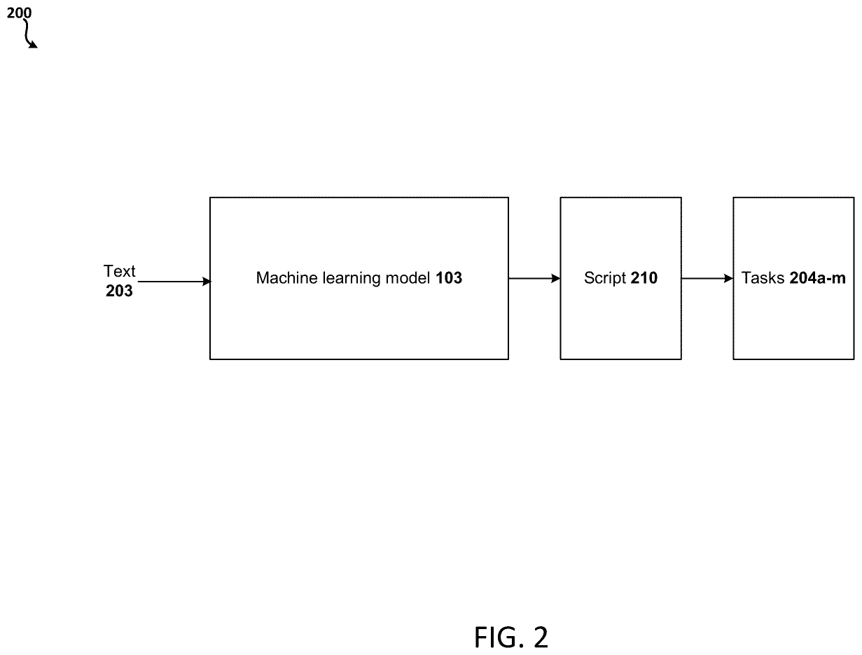

FIG. 2 shows an example diagram 200 for generating tasks using the centralized system 100. The machine learning model 103 may receive text 203. The text 203 may indicate instructions for creating a video. The text 203 may indicate objects in the video to be created, a theme, genre, and/or mood of the video to be created, and/or any other feature of the video to be created. The text 203 may be received from a user. The text 203 may be received via a user interface (UI) of the centralized system 100.

The machine learning model 103 may utilize the text 203 to generate a script 210. The machine learning model 103 may directly generate the script 210. Alternatively, the machine learning model 103 may utilize one or more deep learning models trained on a database of scripts and visual narratives. The script 120 may suggest dialogues, narrations, and scene structures for the video to be created. The machine learning model 103 may generate the script 210 from scratch or may generate the script based on refining an existing script. The script 210 may guide the centralized system 100 on how to create the video. For example, the script 210 may indicate a series of scenes in the video to be created. The script 210 may indicate, for each of the scenes, a title, timestamps and/or a duration, text, music, dialogue, and/or anything else describing the scene. The machine learning model 103 may additionally proposes storyboard layouts, providing a visual representation of the script 210 and ensuring continuity and thematic coherence in the video to be created.

The machine learning model 103 may generate a plurality of tasks 204a-n based on the script 210. Each of the plurality of tasks 204a-n may indicate a particular video editing or creation task that needs to be performed to create the video. For example, each of the plurality of tasks 204a-n may indicate a particular video editing or creation task that needs to be performed by a particular one of the plurality of content creation tools. Generating the plurality of tasks 204a-n may comprise generating a plurality of files (e.g., JSON files). Each of the plurality of files may correspond to a particular task of the plurality of tasks 204a-n. Each of the plurality of files may contain the parameters required by the corresponding content creation tool for implementing the corresponding task.

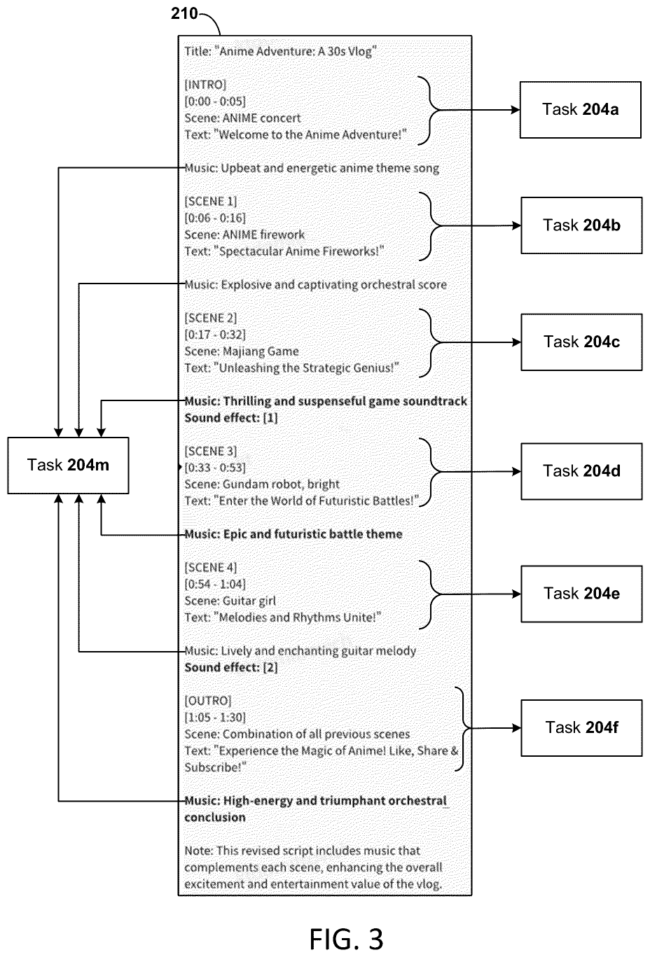

FIG. 3 shows an example script 210. The script 210 may indicate a series of scenes in the video to be created. The script 210 may include dialogues, narrations, and scene structures for the video to be created. The plurality of tasks 204a-n may be generated based on the script 210. For example, each of the plurality of tasks 204a-n may comprise a file (e.g., JSON file) corresponding to a particular task of the plurality of tasks 204a-n. Each of the plurality of files may contain the parameters required by the corresponding content creation tool for performing the corresponding task.

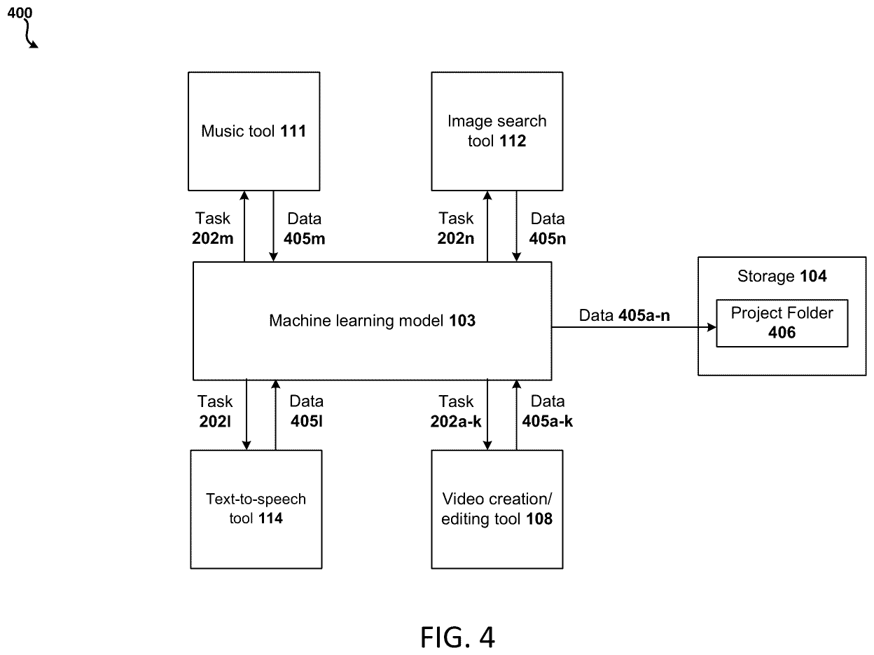

The machine learning model 103 may dispatch (e.g., send) the plurality of tasks 204a-n to at least a subset of the plurality of content creation tools. FIG. 4 shows an example system 400 for dispatching the plurality of tasks 204a-n using the centralized system 100. The machine learning model 103 may dispatch each of the plurality of tasks 204a-n to the content creation tool that is configured to perform that particular task. Dispatching the plurality of tasks 204a-n to the plurality of content creation tools may comprise transmitting the plurality of files to the plurality of content creation tools via the APIs of the plurality of content creation tools.

For example, tasks 204a-k may be dispatched to the video creation/editing tool 108. The video creation/editing tool 108 may be configured to perform the tasks 204a-k. Dispatching the tasks 204a-k to the video creation/editing tool 108 may comprise sending the files containing the parameters required by the video creation/editing tool 108 for performing the tasks 204a-k. Task 2041 may be dispatched to the text-to-speech tool 114. The text-to-speech tool 114 may be configured to perform the task 2041. Dispatching the task 2041 to the text-to-speech tool 114 may comprise sending the file containing the parameters required by the text-to-speech tool 114 for performing the task 2041. Task 204m may be dispatched to the music tool 111. The music tool 111 may be configured to perform the task 204m. Dispatching the task 204m to the music tool 111 may comprise sending the file containing the parameters required by the music tool 111 for performing the task 204m. Task 204n may be dispatched to the image search tool 112. The image search tool 112 may be configured to perform the task 204n. Dispatching the task 204n to the image search tool 112 may comprise sending the file containing the parameters required by the image search tool 112 for performing the task 204n.

The plurality of content creation tools may simultaneously perform (e.g., execute) the plurality of tasks 204a-n. For example, the video creation/editing tool 108, the text-to-speech tool 114, the music tool 111, and the image search tool 112 may simultaneously perform the tasks 204a-k, the task 2041, the task 204m, and the task 204n, respectively. One or more of the plurality of content creation tools may be associated with various agents. The various agents may be configured to simultaneously perform (e.g., execute) tasks. For example, the video creation/editing tool 108 may be associated with various agents. Each of the various agents may be configured to perform one of the tasks 204a-k. The agents may be configured to simultaneously perform the tasks 204a-k. As such, each of the plurality of tasks 204a-n may be executed simultaneously (e.g., in parallel), thereby speeding up the video creation process.

The machine learning model 103 may collect data 405a-n from the plurality of content creation tools. The data 405a-n may indicate the results of the plurality of tasks. For example, video creation/editing tool 108 may perform (e.g., execute) the tasks 204a-k to generate the data 405a-k. The video creation/editing tool 108 may send the data 405a-k to the machine learning model 103 and/or the machine learning model 103 may request the data 405a-k from the video creation/editing tool 108. The text-to-speech tool 114 may perform (e.g., execute) the tasks 2041 to generate the data 4051. The text-to-speech tool 114 may send the data 4051 to the machine learning model 103 and/or the machine learning model 103 may request the data 4051 from the text-to-speech tool 114. The music tool 111 may perform (e.g., execute) the tasks 204m to generate the data 405m. The music tool 111 may send the data 405m to the machine learning model 103 and/or the machine learning model 103 may request the data 405m from the music tool 111. The image search tool 112 may perform (e.g., execute) the tasks 204n to generate the data 405n. The image search tool 112 may send the data 405n to the machine learning model 103 and/or the machine learning model 103 may request the data 405n from the image search tool 112.

The machine learning model 103 may send (e.g., forward) the collected data 405a-n. The machine learning model 103 may send (e.g., forward) the collected data 405a-n to a storage 407. The storage 407 may be located on a server, such as a server that is located remotely from the machine learning model 103. The collected data 405a-n may be stored in a project folder 406. The project folder 406 may be stored in a secure, sandbox environment. The machine learning model 103 may additionally send (e.g., forward) the collected data 405a-n to the video creation/editing tool 108 for generating the video.

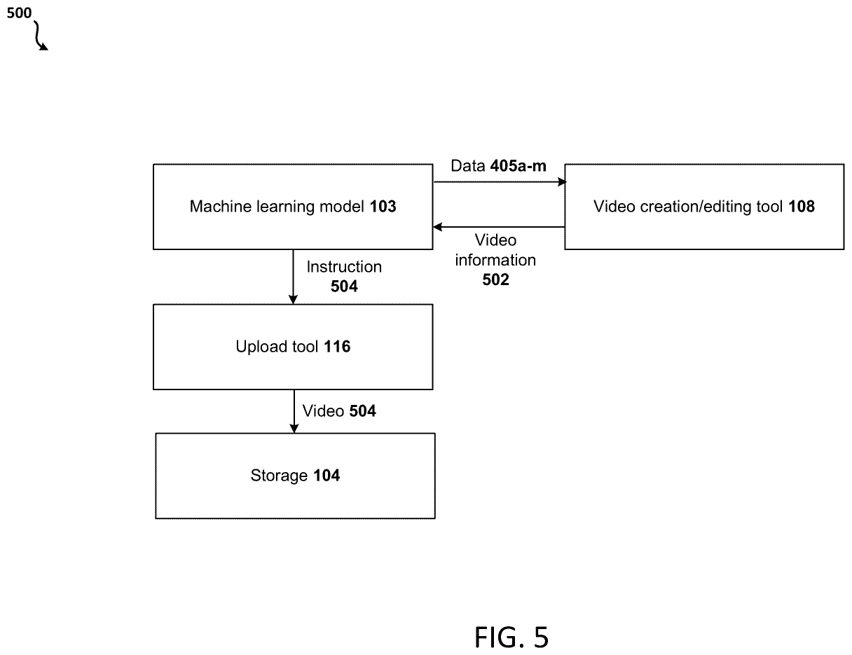

FIG. 5 shows an example system 500 for generating videos using the centralized system 100. The machine learning model 103 may send (e.g., forward) the collected data 405a-n to the video creation/editing tool 108 for generating the video. The video creation/editing tool 108 may generate the video based on the collected data 405a-n. The video creation/editing tool 108 may send information 504 associated with the generated video back to the machine learning model 103. Based on (e.g., in response to receiving) the information 504, the machine learning model 103 may utilize the upload tool 116 to upload the generated video 506 to the storage 407. The machine learning model 103 may utilize the upload tool 116 to automatically upload the generated video 506 to the storage 407 based on (e.g., in response to receiving) the information 504. For example, the machine learning model 103 may utilize the upload tool 116 to upload the generated video 506 to the project folder 406.

In embodiments, the machine learning model 103 may be configured to cause display of information on the UI of the centralized system 100. The user may be able to utilize the information displayed on the UI for accessing the video generated based on the collected data. The information displayed on the UI may comprise the video itself. Alternatively, the information displayed on the UI may comprise a selectable link to the video. For example, the information displayed on the UI may comprise a link, that when selected by the user, may cause the user to be redirected to a page that displays the video.

In embodiments, the machine learning model 103 may edit a video, instead of generating a video from scratch. A user may upload a video clip via the UI of the centralized system 100. The user may enter text that indicates instructions for editing the video clip. The machine learning model 103 may generate an analysis of the video clip. The machine learning model 103 may generate an analysis of the video clip using the video analysis tool 106.

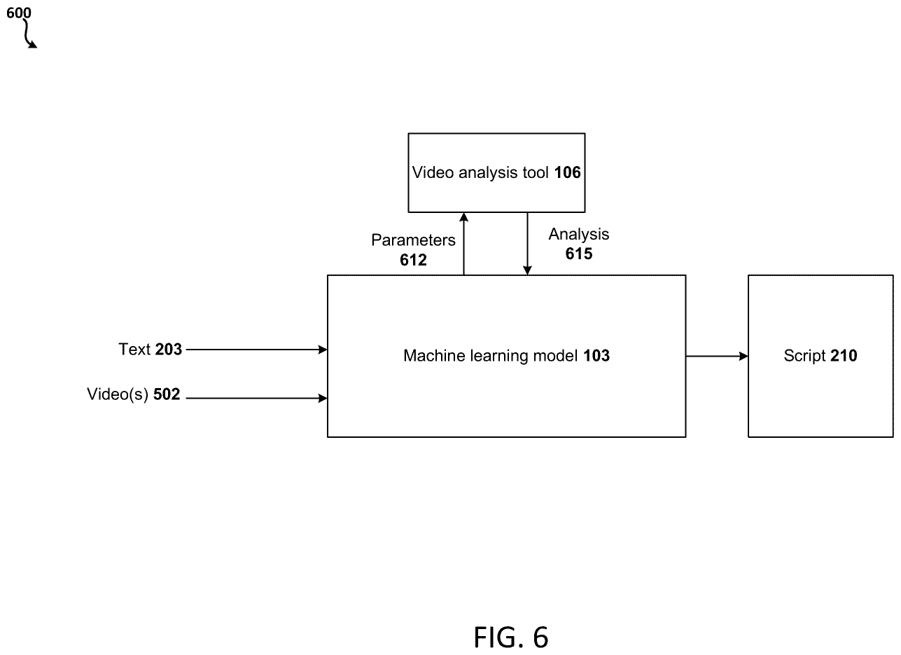

FIG. 6 shows an example diagram 600 for generating a video analysis of video clip(s) using the centralized system 100. The centralized system 100 may receive one or more video clips 602. The centralized system 100 may utilize the machine learning model 103 to send parameters 612 associated with the video clip(s) 602 to the video analysis tool 106. For example, the machine learning model 103 may send an API request including the parameters 612 to an API of the video analysis tool 106. The parameters 612 may include, for example, a location (e.g., uniform resource locator) of the video clip(s) 602, an API key for the API of the video analysis tool 106, and/or a model name (e.g., theme model, object model, etc.). The machine learning model 103 may send a file (e.g., JSON file) including the parameters 612 associated with the video clip(s) 602 to the video analysis tool 106.

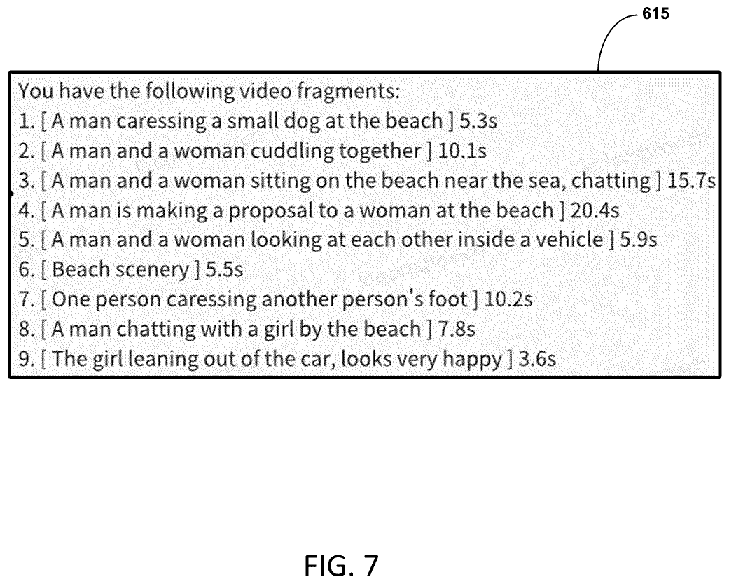

The video analysis tool 106 may generate an analysis 615 of the video clip(s) 602. The analysis 615 may indicate objects and themes detected in the video clip(s) 602. FIG. 7 shows an example analysis 615. As shown in the example of FIG. 7, the analysis 615 may indicate various fragments in the video clip(s) 602, including objects, themes, locations, scenes, etc. and corresponding timestamps. The machine learning model 103 may utilize the video analysis 615 and the text 203 to generate the script 210. The machine learning model 103 may utilize the script 210 to generate the plurality of tasks 204a-n for editing the video clip(s) 602. The machine learning model 103 may dispatch the plurality of tasks 204a-n to the plurality of content creation tools for editing the video clip(s) 602.

Upon receiving raw materials and user inputs, the centralized system 100 begins a preliminary assembly, presenting a rough cut to the user. Based on feedback, the centralized system 100 may perform real-time edits, dynamically reassemble scenes, adjust audio-visual elements, and even suggest changes to enhance the narrative or aesthetic appeal. Users can request changes in real time, with the centralized system 100 adjusting parameters and instantly showcasing the revised content.

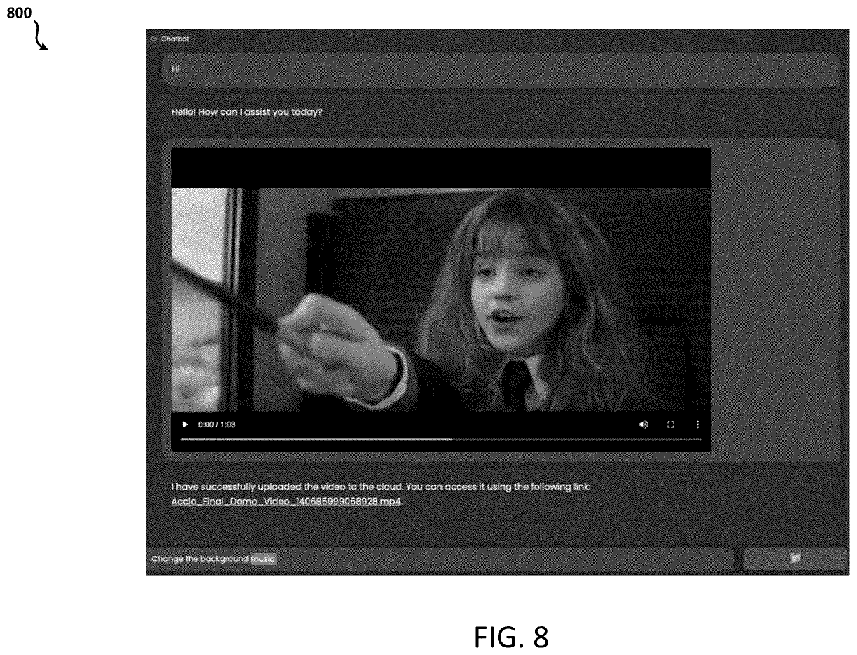

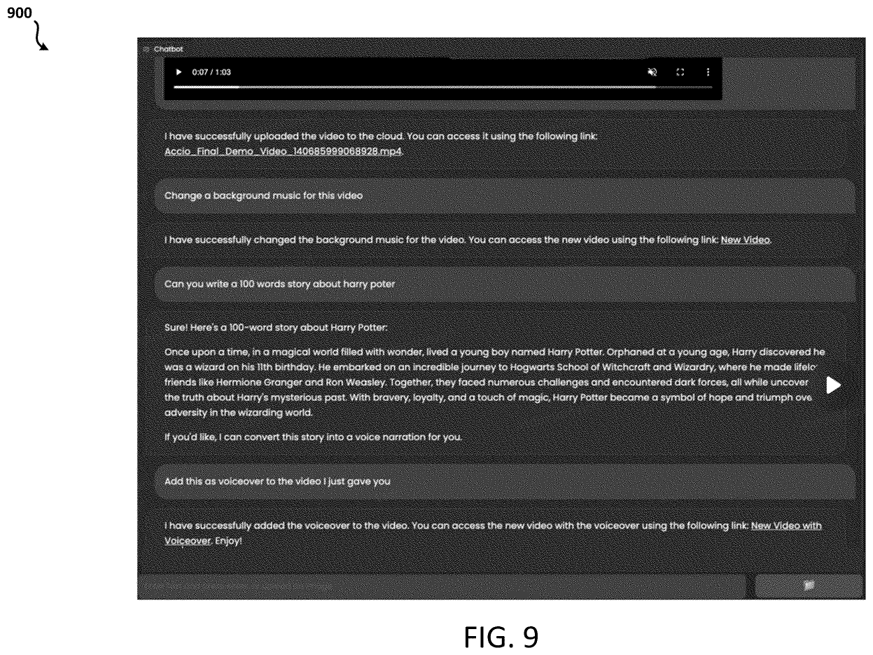

FIGS. 8-9 show example user interfaces (UIs) 800-900 of the centralized system 100 for implementing dialog-based video editing. As shown in FIGS. 8-9, a user may be able to communicate with the centralized system 100 in natural language. The user may upload a video clip 802. The user may upload the video clip 802 by selecting a button 801 on a UI of the centralized system 100. The machine learning model 103 may utilize the upload tool 116 to upload the video clip 802 to the storage 407. The machine learning model 103 may cause output of information 804 that may be used to access the video clip 802 from the storage 407. The user may input text 806 indicating an editing task that the user wants the centralized system 100 to perform on the video clip 802. For example, the text 806 may indicate that the user wants the centralized system 100 to add background music to the video clip 802. The text 806 may be input in natural language form. The user may input the text 806 via keyboard, keypad, voice command, etc.

The machine learning model 103 may utilize one or more of the plurality of content creation tools for editing the video clip(s) 802. The machine learning model 103 may display information 902 (e.g., in natural language) for accessing the edited video. The information 902 displayed on the UI may comprise the edited video itself. Alternatively, the information 902 displayed on the UI may comprise a selectable link to the edited video. For example, the information 902 displayed on the UI may comprise a link, that when selected by the user, may cause the user to be redirected to a page that displays the edited video.

The user may want to further modify the edited video. The user may input text 904 requesting that the centralized system 100 generate a story. The centralized system 100 may utilize the machine learning model 103 to generate and cause output of the story 906. In embodiments, the machine learning model 103 may generate the story 906 without utilizing any of the plurality of content creation tools. The user may input text 908 requesting that the centralized system 100 add the story 906 as a narration (e.g., voiceover) to the edited video.

The machine learning model 103 may utilize one or more of the plurality of content creation tools to add the story 906 as a narration (e.g., voiceover) to the edited video. The machine learning model 103 may display information 910 (e.g., in natural language) for accessing the further edited video. The information 910 displayed on the UI may comprise the further edited video itself. Alternatively, the information 910 displayed on the UI may comprise a selectable link to the further edited video. For example, the information 910 displayed on the UI may comprise a link, that when selected by the user, may cause the user to be redirected to a page that displays the further edited video. The user may continue to input text to further modify the video until the user is satisfied with the video.

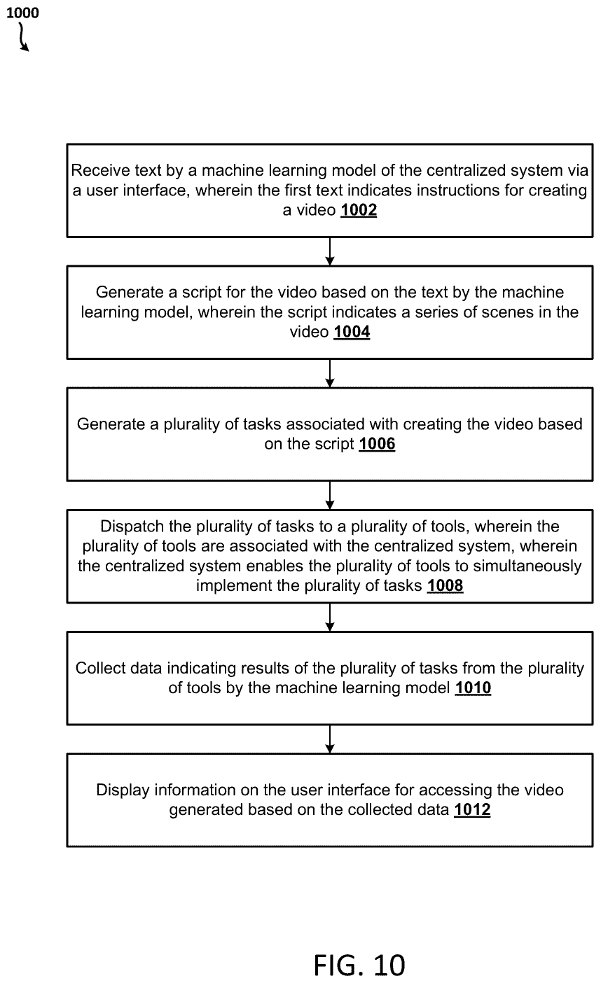

FIG. 10 illustrates an example process 1000 for generating videos using a centralized system (e.g., the centralized system 100). Although depicted as a sequence of operations in FIG. 10, those of ordinary skill in the art will appreciate that various embodiments may add, remove, reorder, or modify the depicted operations.

At 1002, text may be received by a machine learning model of a centralized system. The text may be received via a user interface of the centralized system. The text may indicate instructions for creating a video. The text may indicate objects in the video to be created, a theme, genre, and/or mood of the video to be created, and/or any other feature of the video to be created. The text may be received from a user. The machine learning model may utilize the text to generate a script. At 1004, a script may be generated. The script may be a script for the video. The script may be generated based on the text. The script may be generated by the machine learning model. The script may indicate a series of scenes in the video. The script may guide the centralized system on how to create the video. For example, the script may indicate a series of scenes in the video to be created. The script may indicate, for each of the scenes, a title, timestamps and/or a duration, text, music, dialogue, and/or anything else describing the scene.

At 1006, a plurality of tasks may be generated. The plurality of tasks may be associated with creating the video. The plurality of tasks may be generated based on the script. Each of the plurality of tasks may indicate a particular video editing or creation task that needs to be performed to create the video. For example, each of the plurality of tasks may indicate a particular video editing or creation task that needs to be performed by a particular one of a plurality of tools of the centralized system.

At 1008, the plurality of tasks may be dispatched. The plurality of tasks may be dispatched to the plurality of tools. The centralized system may enable the plurality of tools to simultaneously implement the plurality of tasks. The plurality of tools may simultaneously perform (e.g., execute) the plurality of tasks, thereby speeding up the video creation process. At 1010, data may be collected. The data may indicate results of the plurality of tasks. The data may be received from the plurality of tools by the machine learning model. The video may be generated based on the collected data. At 1012, information may be displayed. The information may be displayed on the user interface. The information may be used for accessing the video generated based on the collected data. The information displayed on the UI may comprise the video itself. Alternatively, the information displayed on the UI may comprise a selectable link to the video. For example, the information displayed on the UI may comprise a link, that when selected by the user, may cause the user to be redirected to a page that displays the video.

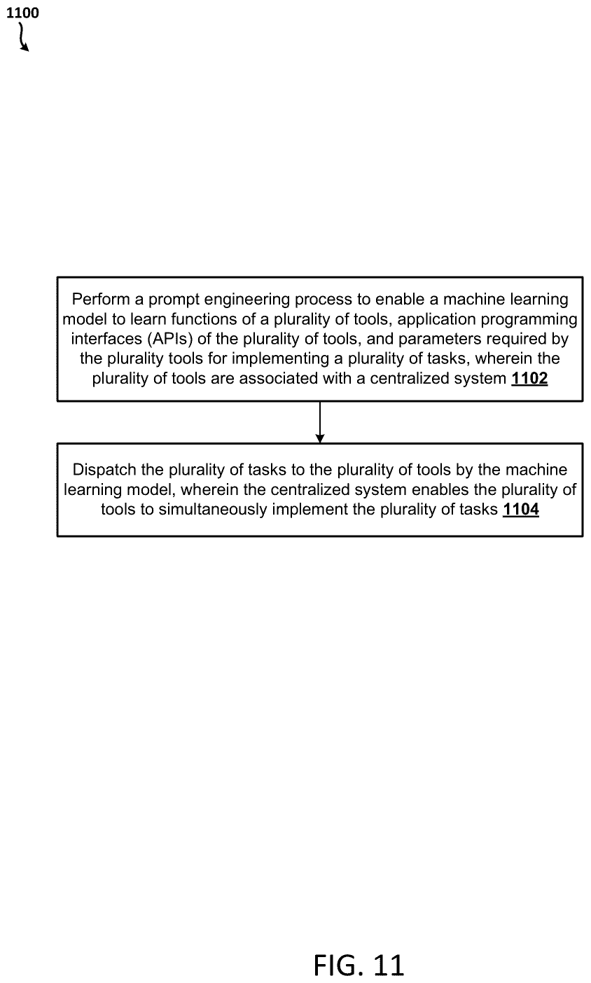

FIG. 11 illustrates an example process 1100 for generating videos using a centralized system (e.g., the centralized system 100). Although depicted as a sequence of operations in FIG. 11, those of ordinary skill in the art will appreciate that various embodiments may add, remove, reorder, or modify the depicted operations.

At 1102, a prompt engineering process may be performed. The prompt engineering process may be performed to enable a machine learning model of the centralized system to learn functions of a plurality of tools. The prompt engineering process may be performed to enable a machine learning model to learn application programming interfaces (APIs) of the plurality of tools. The prompt engineering process may be performed to enable a machine learning model to learn parameters required by the plurality tools for implementing a plurality of tasks. The machine learning model and the plurality of tools may be associated with the centralized system.

Performing the prompt engineering process may comprise inputting text descriptions into the machine learning model. The text may describe a function of each of the plurality of tools. For example, the following text may be input into the UI: text describing that a video analysis tool is configured to analyze a video and generate tags corresponding to the analysis, text describing that a video creation/editing tool is configured to generate a video or edit a video, text describing that a music tool is configured to recommend and/or generate music for a video, text describing that an image search tool is configured to recommend and/or generate an image, such as a cover image, for a video, text describing that a text-to-speech tool is configured to generate voiceovers or speech audio for a video, and text describing that an upload tool is configured to upload content to a server (e.g., cloud server).

In embodiments, the text input into the machine learning model during the prompt engineering process may further describe an API of each of the plurality of tools. The machine learning model may communicate with each of the plurality of tools by calling the API of the corresponding tool. Each of the plurality of tools may require a certain set of parameters to perform the corresponding task. The text input into the machine learning model during the prompt engineering process may further describe the parameters required by each of the plurality of tools for implementing the corresponding task.

At 1104, a plurality of tasks may be dispatched. The plurality of tasks may be dispatched to the plurality of tools. The centralized system may enable the plurality of tools to simultaneously implement the plurality of tasks. The plurality of tools may simultaneously perform (e.g., execute) the plurality of tasks, thereby speeding up the video creation process.

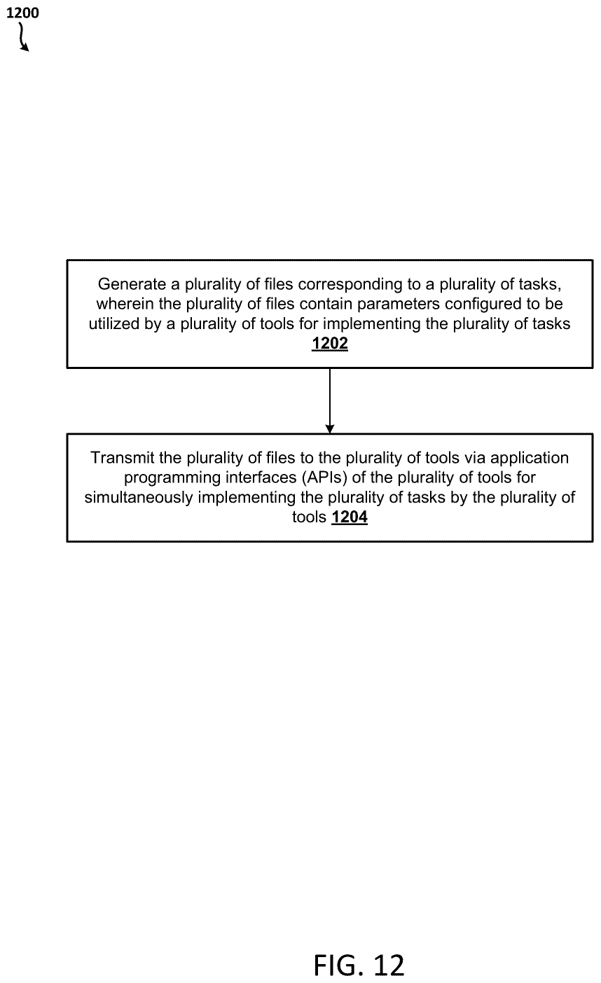

FIG. 12 illustrates an example process 1200 for generating and dispatching tasks using a centralized system (e.g., the centralized system 100). Although depicted as a sequence of operations in FIG. 12, those of ordinary skill in the art will appreciate that various embodiments may add, remove, reorder, or modify the depicted operations.

A machine learning model of a centralized system may generate a plurality of tasks based on a script. Each of the plurality of tasks may indicate a particular video editing or creation task that needs to be performed to create a video. For example, each of the plurality of tasks may indicate a particular video editing or creation task that needs to be performed by a particular one of the plurality of content creation tools. Generating the plurality of tasks may comprise generating a plurality of files. At 1202, a plurality of files may be generated. The plurality of files may correspond to a plurality of tasks. The plurality of files may contain parameters configured to be utilized by a plurality of tools for implementing the plurality of tasks. Each of the plurality of files may be a JSON file.

The machine learning model may dispatch (e.g., send) the plurality of tasks to at least a subset of the plurality of tools. Dispatching the plurality of tasks to the plurality of content creation tools may comprise transmitting the plurality of files to the plurality of tools. At 1204, the plurality of files may be transmitted. The plurality of files may be transmitted to the plurality of tools. The plurality of files may be transmitted to the plurality of tools via application programming interfaces (APIs) of the plurality of tools for simultaneously implementing the plurality of tasks by the plurality of tools.

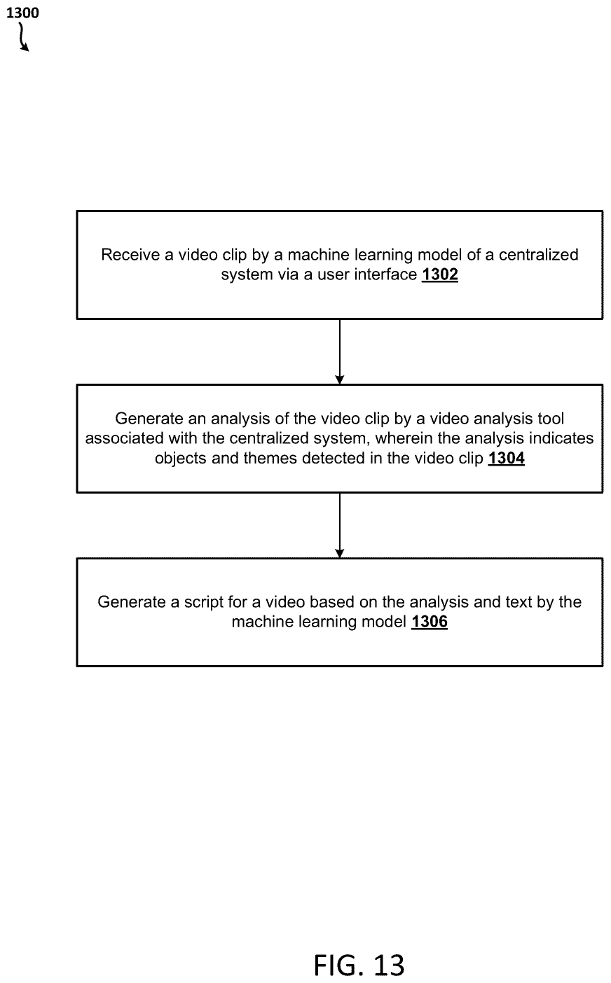

FIG. 13 illustrates an example process 1300 for generating videos using a centralized system (e.g., the centralized system 100). Although depicted as a sequence of operations in FIG. 13, those of ordinary skill in the art will appreciate that various embodiments may add, remove, reorder, or modify the depicted operations.

A machine learning model of a centralized system may edit a video, instead of generating a video from scratch. A user may upload a video clip via a UI of the centralized system. The user may enter text that indicates instructions for editing the video clip. At 1302, a video clip may be received. The video clip may be received by the machine learning model.

At 1304, an analysis of the video clip may be generated. The analysis of the video clip may be generated by a video analysis tool associated with the centralized system, wherein the analysis indicates objects and themes detected in the video clip. The machine learning model may send parameters associated with the video clip to the video analysis tool. For example, the machine learning model may send an API request including the parameters to an API of the video analysis tool. The parameters may include, for example, a location (e.g., uniform resource locator) of the video clip(s), an API key for the API of the video analysis tool, and/or a model name (e.g., theme model, object model, etc.). The machine learning model may send a file (e.g., JSON file) including the parameters associated with the video clip(s) to the video analysis tool. The video analysis tool may generate the analysis based on the parameters.

At 1306, a script may be generated. The script may be a script for the edited video. The script may be generated based on the analysis and text by the machine learning model of the centralized system. The machine learning model may utilize the script to generate a plurality of tasks for editing the video clip. The machine learning model may dispatch the plurality of tasks to the plurality of tools for editing the video clip.

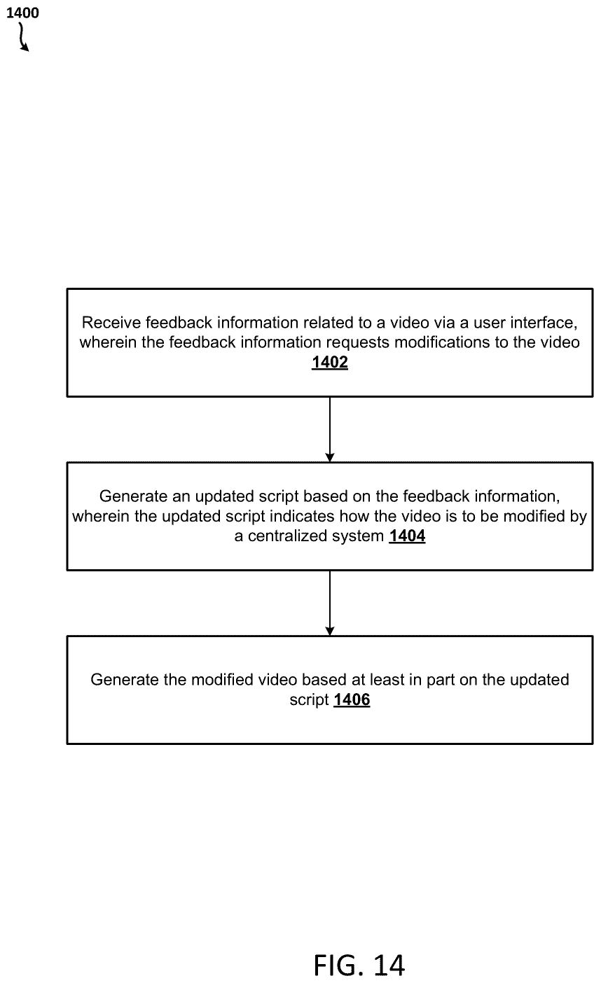

FIG. 14 illustrates an example process 1400 for modifying videos using a centralized system (e.g., the centralized system 100). Although depicted as a sequence of operations in FIG. 14, those of ordinary skill in the art will appreciate that various embodiments may add, remove, reorder, or modify the depicted operations.

A user may be able to communicate with a video creation/editing system (e.g., the centralized system 100) in natural language. A machine learning model of the centralized system may utilize one or more of a plurality of tools for creating or editing a video. The machine learning model may display information for accessing the video. The information displayed on the UI may comprise the video itself. Alternatively, the information displayed on the UI may comprise a selectable link to the video. For example, the information displayed on the UI may comprise a link, that when selected by the user, may cause the user to be redirected to a page that displays the edited video. The user may want to modify the video. At 1402, feedback information (e.g., text) may be received. The feedback information may be related to the video. The feedback information may request modifications to the video. The feedback information may be received via a user interface.

The machine learning model may utilize the feedback information to generate an updated script. At 1404, an updated script may be generated. The updated script may be generated based on the feedback information. The updated script may indicate how the video is to be modified by the centralized system. The updated script may guide the centralized system on how to modify the video. For example, the updated script may indicate a series of scenes in the modified video. The script may indicate, for each of the scenes, a title, timestamps and/or a duration, text, music, dialogue, and/or anything else describing the scene.

The machine learning model may generate a plurality of tasks based on the updated script. Each of the plurality of tasks may indicate a particular video editing task that needs to be performed to modify video. For example, each of the plurality of tasks may indicate a particular video editing task that needs to be performed by a particular one of a plurality of tools. At 1406, the modified video may be generated. The modified video may be generated based at least in part on the updated script. For example, the modified video may be generated based at least in part on dispatching the plurality of tasks to the plurality of tools.

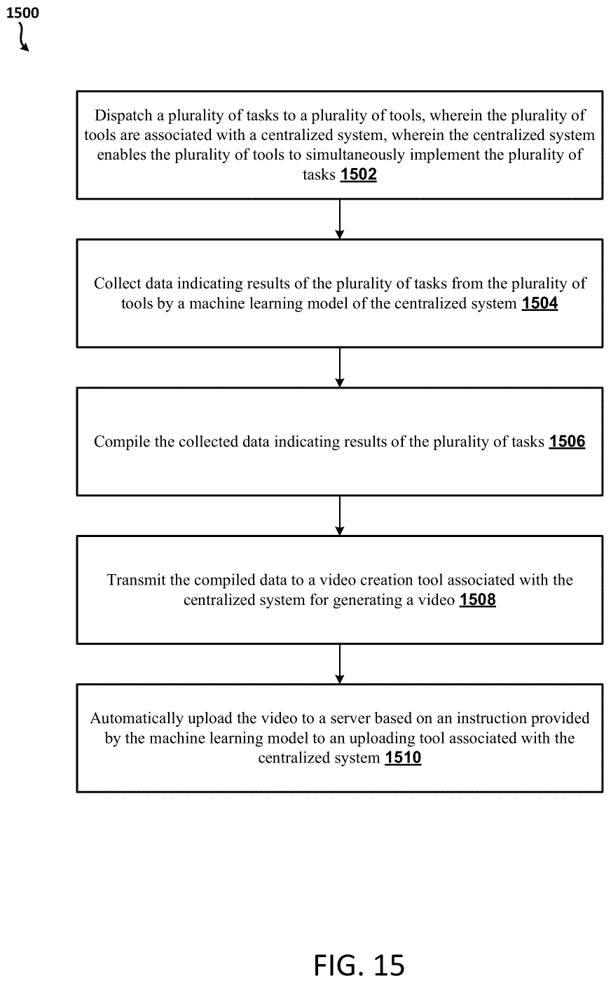

FIG. 15 illustrates an example process 1500 for generating videos using a centralized system (e.g., the centralized system 100). Although depicted as a sequence of operations in FIG. 15, those of ordinary skill in the art will appreciate that various embodiments may add, remove, reorder, or modify the depicted operations.

At 1502, a plurality of tasks may be dispatched. The plurality of tasks may be dispatched to a plurality of tools of a centralized system (e.g., the centralized system 100). The plurality of tasks may be dispatched by a machine learning model of the centralized system. The centralized system may enable the plurality of tools to simultaneously implement the plurality of tasks. The plurality of tools may simultaneously perform (e.g., execute) the plurality of tasks, thereby speeding up the video creation process.

At 1504, data may be collected. The data may indicate results of the plurality of tasks. The data may be collected from the plurality of tools by the machine learning model. A video may be generated based on the collected data. For example, the video may be generated by a video creation (e.g., generation) tool of the centralized system. The video may be generated based at least in part on compiling the collected data and transmitting the compiled data to the video creation tool. At 1506, the collected data indicating results of the plurality of tasks may be compiled. At 1508, the compiled data may be transmitted. The compiled data may be transmitted to the video creation tool associated with the centralized system. The video creation tool may utilize the compiled data for generating the video.

The video creation tool may generate the video based on the compiled data. The video creation tool may send information associated with the generated video back to the machine learning model. Based on (e.g., in response to) receiving the information, the machine learning model may utilize an uploading tool of the centralized system to upload the generated video to a storage, such as a remote storage. At 1510, the video may be automatically uploaded to a server (e.g., a remote server, cloud server). The video may be automatically uploaded to a storage on the server. For example, the video may be automatically uploaded to a project folder on the storage. The project folder may be associated with the video storage on the server. The video may be automatically uploaded to the server based on an instruction provided by the machine learning model to the uploading tool associated with the centralized system.

In embodiments, the machine learning model may be configured to cause display of information on the UI of the centralized system. The user may be able to utilize the information displayed on the UI for accessing the video from the server. The information displayed on the UI may comprise the video itself. Alternatively, the information displayed on the UI may comprise a selectable link to the video. For example, the information displayed on the UI may comprise a link, that when selected by the user, may cause the user to be redirected to a page that displays the video.

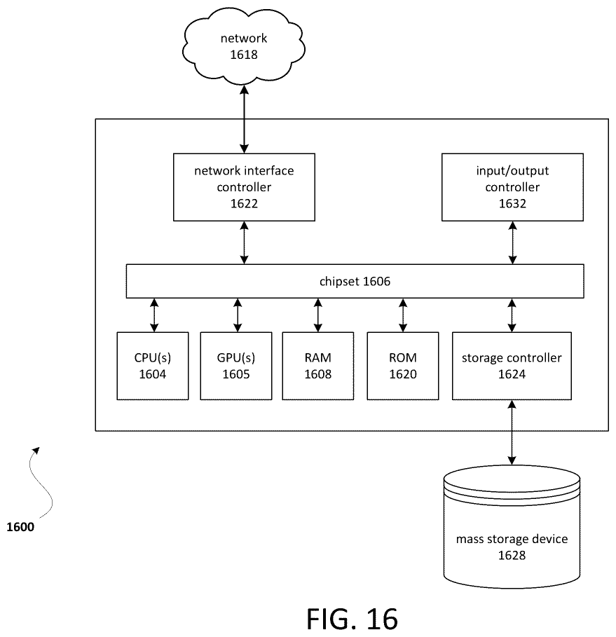

FIG. 16 illustrates a computing device 1600 that may be used in various aspects, such as the services, networks, modules, and/or devices depicted in FIG. 1. With regard to the example system 100 of FIG. 1, any of its components may each be implemented by one or more instance of a computing device 1600 of FIG. 16. The computer architecture shown in FIG. 16 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1600 may include a baseboard, or “motherboard,” which is a printed circuit board to which a multitude of components or devices may be connected by way of a system bus or other electrical communication paths. One or more central processing units (CPUs) 1604 may operate in conjunction with a chipset 1606. The CPU(s) 1604 may be standard programmable processors that perform arithmetic and logical operations necessary for the operation of the computing device 1600.

The CPU(s) 1604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1604 may be augmented with or replaced by other processing units, such as GPU(s) 1605. The GPU(s) 1605 may comprise processing units specialized for but not necessarily limited to highly parallel computations, such as graphics and other visualization-related processing.

A chipset 1606 may provide an interface between the CPU(s) 1604 and the remainder of the components and devices on the baseboard. The chipset 1606 may provide an interface to a random-access memory (RAM) 1608 used as the main memory in the computing device 1600. The chipset 1606 may further provide an interface to a computer-readable storage medium, such as a read-only memory (ROM) 1620 or non-volatile RAM (NVRAM) (not shown), for storing basic routines that may help to start up the computing device 1600 and to transfer information between the various components and devices. ROM 1620 or NVRAM may also store other software components necessary for the operation of the computing device 1600 in accordance with the aspects described herein.

The computing device 1600 may operate in a networked environment using logical connections to remote computing nodes and computer systems through local area network (LAN). The chipset 1606 may include functionality for providing network connectivity through a network interface controller (NIC) 1622, such as a gigabit Ethernet adapter. A NIC 1622 may be capable of connecting the computing device 1600 to other computing nodes over a network 1618. It should be appreciated that multiple NICs 1622 may be present in the computing device 1600, connecting the computing device to other types of networks and remote computer systems.

The computing device 1600 may be connected to a mass storage device 1628 that provides non-volatile storage for the computer. The mass storage device 1628 may store system programs, application programs, other program modules, and data, which have been described in greater detail herein. The mass storage device 1628 may be connected to the computing device 1600 through a storage controller 1624 connected to the chipset 1606. The mass storage device 1628 may consist of one or more physical storage units. The mass storage device 1628 may comprise a management component. A storage controller 1624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1600 may store data on the mass storage device 1628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1628 is characterized as primary or secondary storage and the like.

For example, the computing device 1600 may store information to the mass storage device 1628 by issuing instructions through a storage controller 1624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1600 may further read information from the mass storage device 1628 by detecting the physical states or characteristics of one or more particular locations within the physical storage units.

In addition to the mass storage device 1628 described above, the computing device 1600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1628 depicted in FIG. 16, may store an operating system utilized to control the operation of the computing device 1600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1628 may store other system or application programs and data utilized by the computing device 1600.

The mass storage device 1628 or other computer-readable storage media may also be encoded with computer-executable instructions, which, when loaded into the computing device 1600, transforms the computing device from a general-purpose computing system into a special-purpose computer capable of implementing the aspects described herein. These computer-executable instructions transform the computing device 1600 by specifying how the CPU(s) 1604 transition between states, as described above. The computing device 1600 may have access to computer-readable storage media storing computer-executable instructions, which, when executed by the computing device 1600, may perform the methods described herein.

A computing device, such as the computing device 1600 depicted in FIG. 16, may also include an input/output controller 1632 for receiving and processing input from a number of input devices, such as a keyboard, a mouse, a touchpad, a touch screen, an electronic stylus, or other type of input device. Similarly, an input/output controller 1632 may provide output to a display, such as a computer monitor, a flat-panel display, a digital projector, a printer, a plotter, or other type of output device. It will be appreciated that the computing device 1600 may not include all of the components shown in FIG. 16, may include other components that are not explicitly shown in FIG. 16, or may utilize an architecture completely different than that shown in FIG. 16.

As described herein, a computing device may be a physical computing device, such as the computing device 1600 of FIG. 16. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method for generating videos using a centralized system, comprising:
receiving text by a machine learning model of the centralized system via a user interface, wherein the text indicates instructions for creating a video;
generating a script for the video based on the text by the machine learning model, wherein the script indicates a series of scenes in the video;
generating a plurality of tasks associated with creating the video based on the script;
dispatching the plurality of tasks to a plurality of tools, wherein the plurality of tools are associated with the centralized system, wherein the centralized system enables the plurality of tools to simultaneously implement the plurality of tasks;
collecting data indicating results of the plurality of tasks from the plurality of tools by the machine learning model; and
displaying information on the user interface for accessing the video generated based on the collected data.

2. The method of claim 1, further comprising:
performing a prompt engineering process to enable the machine learning model to learn functions of the plurality of tools, application programming interfaces (APIs) of the plurality of tools, and parameters required by the plurality tools for implementing the plurality of task.

3. The method of claim 1, further comprising:
generating a plurality of files corresponding to the plurality of tasks, wherein the plurality of files contains parameters configured to be utilized by the plurality of tools for implementing the plurality of tasks.

4. The method of claim 3, further comprising:
transmitting the plurality of files to the plurality of tools via application programming interfaces (APIs) of the plurality of tools for simultaneously implementing the plurality of tasks by the plurality of tools.

5. The method of claim 1, further comprising:
receiving a video clip by the machine learning model via the user interface;
generating an analysis of the video clip by a video analysis tool associated with the centralized system, wherein the analysis indicates objects and themes detected in the video clip; and
generating the script based on the analysis and the text by the machine learning model.

6. The method of claim 1, further comprising:
receiving feedback information related to the video via the user interface, wherein the feedback information requests modifications to the video;
generating an updated script based on the feedback information, wherein the updated script indicates how the video is to be modified by the centralized system; and
generating the modified video based at least in part on the updated script.

7. The method of claim 1, further comprising:
compiling the collected data indicating results of the plurality of tasks; and
transmitting the compiled data to a video creation tool associated with the centralized system for generating the video.

8. The method of claim 1, further comprising:
automatically uploading the video to a server based on an instruction provided by the machine learning model to an uploading tool associated with the centralized system.

9. The method of claim 1, wherein the plurality of tools comprises a video editing tool, a music recommendation tool, an image searching tool configured to search images based on a user input, and a text-to-speech tool configured to generate speech audio based on an input text.

10. The method of claim 1, wherein the video comprises images, music, speech audio, and text.

11. A system for generating videos using a centralized system, comprising:
at least one processor; and
at least one memory comprising computer-readable instructions that upon execution by the at least one processor cause the system to perform operations comprising:
receiving text by a machine learning model of the centralized system via a user interface, wherein the text indicates instructions for creating a video;
generating a script for the video based on the text by the machine learning model, wherein the script indicates a series of scenes in the video;
generating a plurality of tasks associated with creating the video based on the script;
dispatching the plurality of tasks to a plurality of tools, wherein the plurality of tools are associated with the centralized system, wherein the centralized system enables the plurality of tools to simultaneously implement the plurality of tasks;
collecting data indicating results of the plurality of tasks from the plurality of tools by the machine learning model; and
displaying information on the user interface for accessing the video generated based on the collected data.

12. The system of claim 11, the operations further comprising:
performing a prompt engineering process to enable the machine learning model to learn functions of the plurality of tools, application programming interfaces (APIs) of the plurality of tools, and parameters required by the plurality tools for implementing the plurality of task.

13. The system of claim 11, the operations further comprising:
generating a plurality of files corresponding to the plurality of tasks, wherein the plurality of files contains parameters configured to be utilized by the plurality of tools for implementing the plurality of tasks; and
transmitting the plurality of files to the plurality of tools via application programming interfaces (APIs) of the plurality of tools for simultaneously implementing the plurality of tasks by the plurality of tools.

14. The system of claim 11, the operations further comprising:
receiving a video clip by the machine learning model via the user interface;
generating an analysis of the video clip by a video analysis tool associated with the centralized system, wherein the analysis indicates objects and themes detected in the video clip; and
generating the script based on the analysis and the text by the machine learning model.

15. The system of claim 11, the operations further comprising:
receiving feedback information related to the video via the user interface, wherein the feedback information requests modifications to the video;
generating an updated script based on the feedback information, wherein the updated script indicates how the video is to be modified by the centralized system; and
generating the modified video based at least in part on the updated script.

16. A non-transitory computer-readable storage medium, storing computer-readable instructions that upon execution by a processor cause the processor to implement operations, the operation comprising:
receiving text by a machine learning model of the centralized system via a user interface, wherein the text indicates instructions for creating a video;
generating a script for the video based on the text by the machine learning model, wherein the script indicates a series of scenes in the video;
generating a plurality of tasks associated with creating the video based on the script;
dispatching the plurality of tasks to a plurality of tools, wherein the plurality of tools are associated with the centralized system, wherein the centralized system enables the plurality of tools to simultaneously implement the plurality of tasks;
collecting data indicating results of the plurality of tasks from the plurality of tools by the machine learning model; and
displaying information on the user interface for accessing the video generated based on the collected data.

17. The non-transitory computer-readable storage medium of claim 16, the operations further comprising:
performing a prompt engineering process to enable the machine learning model to learn functions of the plurality of tools, application programming interfaces (APIs) of the plurality of tools, and parameters required by the plurality tools for implementing the plurality of task.

18. The non-transitory computer-readable storage medium of claim 16, the operations further comprising:
generating a plurality of files corresponding to the plurality of tasks, wherein the plurality of files contains parameters configured to be utilized by the plurality of tools for implementing the plurality of tasks; and
transmitting the plurality of files to the plurality of tools via application programming interfaces (APIs) of the plurality of tools for simultaneously implementing the plurality of tasks by the plurality of tools.

19. The non-transitory computer-readable storage medium of claim 16, the operations further comprising:
receiving a video clip by the machine learning model via the user interface;
generating an analysis of the video clip by a video analysis tool associated with the centralized system, wherein the analysis indicates objects and themes detected in the video clip; and
generating the script based on the analysis and the text by the machine learning model.

20. The non-transitory computer-readable storage medium of claim 16, the operations further comprising:
receiving feedback information related to the video via the user interface, wherein the feedback information requests modifications to the video;
generating an updated script based on the feedback information, wherein the updated script indicates how the video is to be modified by the centralized system; and
generating the modified video based at least in part on the updated script.
